(19) United States
(12) Patent Application Publication
(10) Pub. No.: US 2003/0057156 A1
(43) Pub. Date: Mar. 27, 2003

(54) Atrial filter implants

(76) Inventors: Dean Peterson, Brooklyn Park, MN (US); Gregg S. Sutton, Place North, MN (US); Jeffrey Welch, New Hope, MN (US)

Correspondence Address: FISH & NEAVE, 1251 AVENUE OF THE AMERICAS, 50TH FLOOR, NEW YORK, NY, 10020-1105, US

(21) Appl. No.: 10/094,730

(22) Filed: Mar. 8, 2002

Related U.S. Application Data
(60) Provisional application No. 60/274,345, filed on Mar. 8, 2001.
(60) Provisional application No. 60/274,344, filed on Mar. 8, 2001.
(60) Provisional application No. 60/274,289, filed on Mar. 8, 2001.
(60) Provisional application No. 60/287,829, filed on May 1, 2001.

(51) Int. Cl. C02F 1/44

(52) U.S. Cl. 210/645

(57) ABSTRACT

Implant devices for filtering blood flowing through atrial appendage ostiums have elastic cover and anchoring substructures. The substructures may include reversibly folding tines or compressible wire braid structures. The devices are folded to fit in catheter tubes for delivery to the atrial appendages. The devices elastically expand to their natural sizes when they are expelled from the catheter tubes. Filter elements in the covers block emboli from escaping through the ostiums

The devices with tine substructures may have H-shaped cross sections. These devices seal the appendages by pinching an annular region of ostium tissue between the cover and the anchoring substructures. The shallow deployment depth of these H-shaped devices allows use of an universal device size for atrial appendages of varying lengths or depths. The devices may include remotely activated fixtures for refolding the tines for device recovery or position adjustment.

This application claims the benefit of U.S. provisional application No. 60/274,345, filed Mar. 8, 2001, U.S. provisional application No. 60/274,344, filed Mar. 8, 2001, U.S. provisional application No. 60/274,289, filed Mar. 8, 2001 and U.S. provisional application No. 60/287,829, filed May 1, 2001, all of which are hereby incorporated by reference in their entireties herein.

### BACKGROUND OF THE INVENTION

The invention relates to implant devices that may be implanted in an atrial appendage for filtering blood flowing between the atrial appendage and an associated atrium of the heart to prevent thrombi from escaping from the atrial appendage into the body's blood circulation system.

There are a number of heart diseases (e.g., coronary artery disease, mitral valve disease) that have various adverse effects on a patient's heart. An adverse effect of certain cardiac diseases, such as mitral valve disease, is atrial (or auricular) fibrillation. Atrial fibrillation leads to depressed cardiac output. A high incidence of thromboembolic (i.e., blood clot particulate) phenomena are associated with atrial fibrillation, and the left atrial appendage (LAA) is frequently the source of the emboli (particulates).

Thrombi (i.e., blood clots) formation in the LAA may be due to stasis within the fibrillating and inadequately emptying LAA. Blood pooling in the atrial appendage is conducive to the formation of blood clots. Blood clots may accumulate, and build upon themselves. Small or large fragments of the blood clots may break off and propagate out from the atrial appendage into the atrium. The blood clot fragments can then enter the body's blood circulation and embolize distally into the blood stream.

Serious medical problems result from the migration of blood clot fragments from the atrial appendage into the body's blood stream. Blood from the left atrium and ventricle circulates to the heart muscle, the brain, and other body organs, supplying them with necessary oxygen and other nutrients. Emboli generated by blood clots formed in the left atrial appendage may block the arteries through which blood flows to a body organ. The blockage deprives the organ tissues of their normal blood flow and oxygen supply (ischemia), and depending on the body organ involved leads to ischemic events such as heart attacks (heart muscle ischemia) and strokes (brain tissue ischemia).

It is therefore important to find a means of preventing blood clots from forming in the left atrial appendage. It is also important to find a means to prevent fragments or emboli generated by any blood clots that may have formed in the atrial appendages, from propagating through the blood stream to the heart muscle, brain or other body organs.

U.S. Pat. No. 5,865,791 (hereinafter, “the '791 patent”) relates to the reduction of regions of blood stasis in the heart and ultimately reduction of thrombi formation in such regions, particularly in the atrial appendages of patients with atrial fibrillation. More specifically, the '791 patent relates to procedures and devices for affixing the atrial appendages in an orientation that prevents subsequent formation of thrombi. In the '791 patent, the appendage is removed from the atrium by pulling the appendage, placing a loop around the appendage to form a sack, and then cutting it off from the rest of the heart.

U.S. Pat. No. 5,306,234 describes a method for surgically closing the passageway between the atrium and the atrial appendage, or alternatively severing the atrial appendage.

Some recently proposed methods of treatment are directed toward implanting a plug-type device in an atrial appendage to occlude the flow of blood therefrom.

A preventive treatment method for avoiding thromboembolic events (e.g., heart attacks, strokes, and other ischemic events) involves filtering out harmful emboli from the blood flowing out of atrial appendages. Co-pending and co-owned U.S. patent application Ser. No. 09/428,008, U.S. patent application Ser. No. 09/614,091, U.S. patent application Ser. No. 09/642,291, U.S. patent application Ser. No. 09/697,628, and U.S. patent application Ser. No. 09/932,512, all of which are hereby incorporated by reference in their entireties herein, describe filtering devices which may be implanted in an atrial appendage to filter the blood flow therefrom. The devices may be delivered to the atrial appendage using common cardiac catheterization methods. These methods may include transseptal catheterization, which involves puncturing an atrial septum.

Catheters and implant devices that are large may require large punctures in the septum. Large catheters and devices may damage body tissue during delivery or implantation. Damage to body tissue may cause trauma, increase recovery time, increase the risk of complications, and increase the cost of patient care. Further the atrial appendages may vary in shape and size from patient to patient.

U.S. patent application Ser. No. 09/932,512 discloses implant devices which are small and which can be delivered by small-sized catheters to the atrial appendages. A factor in successful device implantation is the secure retention of the implanted device in the atrial appendage. The implant device sizes may be adjusted in situ, for example, to conform to the size of the individual atrial appendages for device retention.

Consideration is now being given to additional implant device designs, to provide a larger variety of devices from which an appropriate device may be chosen, for example, to match an individual atrial appendage.

### SUMMARY OF THE INVENTION

The invention provides implant devices and methods, which may be used to filter blood flowing between atrial appendages and atrial chambers. The devices are designed to prevent the release of blood clots formed in the atrial appendages into the body's blood circulation system.

All devices disclosed herein have elastic structures. The elastic structures allow the devices to be folded or compressed to compact sizes that can fit in narrow diameter tubes for delivery, for example, by cardiac catheterization. The compressed devices elastically expand to their natural sizes when they are expelled from delivery catheter tubes. The devices are shaped so that the deployed devices are retained in position in the atrial appendages in which they are deployed. The devices include suitable filtering elements to filter emboli from blood flow across the atrial appendage.

The devices may include a recovery tube, which recompacts deployed or expanded devices. The recovery tube may be activated remotely using inter catheter shafts or wires. The recompacted devices may be withdrawn into the delivery catheter tube for device recovery or position readjustment.

The implant devices of one embodiment have expandable proximal cover and distal anchoring substructures. The expandable substructures include folding tines. The tines may be made of elastic material, for example, elastic shape-memory alloys. The tines may be folded down along the device axis to compact the devices for catheter tube delivery. In expanded devices, the tines extend radially outward from the middle device portion or section giving the devices an H-shaped cross section.

The proximal covers include blood-permeable filtering elements. The blood filtering elements are designed to prevent passage of harmful-sized emboli. When a device is deployed in an atrial appendage, proximal cover tines engage atrial wall portions surrounding the appendage ostium to seal the appendage. The anchoring tines engage atrial appendage wall tissue. The anchoring tines may be shaped to exert outward elastic pressure against an annular region of ostium wall tissue. The engagement of the atrial wall portions surrounding the ostium by the proximal tines, and the simultaneous engagement of the atrial appendage wall tissue by the anchoring tines combine to pinch an annular region of ostium wall tissue between the proximal cover and the anchoring substructure. This pinching of ostium wall tissue may effectively seal the atrial appendage, and direct blood flow through the proximal blood-permeable filtering elements.

The H-shaped cross section of these devices allows device deployment entirely within the immediate vicinity of an atrial appendage ostium. Therefore, universal-size devices may be suitable implants for atrial appendages of varying lengths or depths.

In other embodiments of the inventive implant devices, a single elastic structure may serve both to filter blood flow and to anchor a deployed device in position. The elastic structure, which has a generally cylindrical shape, is made from wire braid material. Common wire materials such as stainless steel or nitinol are used to form the wire braid. Distal portions of the device structure engage atrial appendage wall tissue to hold an implanted device in position. The proximal end of the cylindrical device structure is closed, and is designed to extend across the ostium of the appendage. Filter membranes on the proximal closed cylindrical ends prevent passage of harmful-size emboli from the atrial appendage. The filter membranes may, for example, be made of polyester fabric. Alternatively, a fine wire or fiber may be interwoven with the device wire braid at the proximal end to form a high-density braid with small interwire hole sizes. The hole sizes can be sufficiently small to allow the high-density braid to filter harmful-size emboli. In some devices, the entire device wire braid structure including both proximal and distal portions may be formed from high-density wire braid material.

Further features of the invention, its nature and various advantages will be more apparent from the accompanying drawing and the following detailed description.

### BRIEF DESCRIPTION OF THE DRAWINGS

FIG. 1a is a perspective view of a supporting frame of an H-shaped implant device in accordance with the principles of the present invention.

FIG. 1b is a perspective view of another type of a supporting frame that may be used in an H-shaped implant device in accordance with the principles of the present invention.

FIG. 1c is a perspective view of the H-shaped implant device of FIG. 1b with a filter element disposed on the supporting frame in accordance with the principles of the invention.

FIG. 2 is a cross sectional view showing the H-shaped implant device of FIG. 1c deployed in an atrial appendage in accordance with the principles of the present invention.

FIG. 3 is a perspective view of another implant device in accordance with the principles of the invention.

FIG. 4 is a cross sectional view showing the implant device of FIG. 3 deployed in an atrial appendage in accordance with the principles of the present invention.

FIG. 5 is a schematic representation of yet another implant device in accordance with the principles of the present invention. The device is shown in a folded position while its is contained within a recovery fixture.

FIG. 6 is a perspective view of the device of FIG. 5 in an expanded position while the device is attached to a delivery system in accordance with the principles of the present invention. Portions of the delivery system are shown.

FIG. 7 is a perspective view partially in cross sectional of the device and delivery system as shown in FIG. 6.

FIG. 8a is a schematic representation of an open end wire-braid implant device in accordance with the principles of the present invention. Portions of a delivery apparatus to which the device is attached are also represented.

FIG. 8b is a schematic representation partially in cross section illustrating the device of FIG. 8a deployed in an atrial appendage.

FIG. 9 is a schematic representation of another wire-braid implant device which is closed at both ends in accordance with the principles of the present invention. Portions of a delivery apparatus to which the device is attached are also represented.

FIG. 10a is a schematic representation of another wire-braid implant device which is closed at both ends in accordance with the principles of the present invention.

FIG. 10b is a schematic representation of the device of FIG. 10a as it is being deployed in an atrial appendage(shown in cross section). Portions of a delivery apparatus of FIG. 9 attached to the device are also shown.

FIG. 11a is a schematic representation of a wire braid implant device having a distinct proximal cover in accordance with the principles of the present invention.

FIG. 11b is a schematic representation of the device of FIG. 11a deployed in an atrial appendage (shown in cross section).

### DESCRIPTION OF THE PREFERRED EMBODIMENTS

Although atrial fibrillation may result in the pooling of blood in the left atrial appendage and the majority of use of the invention is anticipated to be for the left atrial appendage, the invention may also be used for the right atrial appendage and in general for placement in any body cavity from or through which blood is permitted to flow. The invention is directed to preventing blood clots formed in either atrial appendages or other body cavities from entering the bloodstream through the appendage ostiums or body cavity apertures.

The devices of the present invention have elastic structures. The elastic structures allow the devices to be folded or compressed to compact sizes that can fit in narrow diameter catheter tubes. The catheter tubes may be used for percutaneous device delivery to the atrial appendages. Conventional cardiac catheterization techniques may be used for device delivery. The devices are delivered to suitable in vivo locations for deployment in atrial appendages. The compressed devices expand to their natural sizes when they are expelled from and are no longer constrained by the delivery catheter tubes. The devices are shaped so that the deployed devices are retained in position in the atrial appendages in which they are deployed. The devices include suitable filtering elements to filter emboli from blood flow across the atrial appendage. The devices are designed so that when deployed the filtering elements are centered or positioned across the atrial appendage ostium to properly intercept and filter blood flowing out of the atrial appendage. The design of the devices also makes recovery or readjustment of deployed devices possible.

The types of implant devices disclosed herein add to variety of device types disclosed in U.S. patent application Ser. No. 09/428,008, U.S. patent application Ser. No. 09/614,091, U.S. patent application Ser. No. 09/642,291, U.S. patent application Ser. No. 09/697,628, and U.S. patent application Ser. No. 09/932,512, all incorporated in by reference herein.

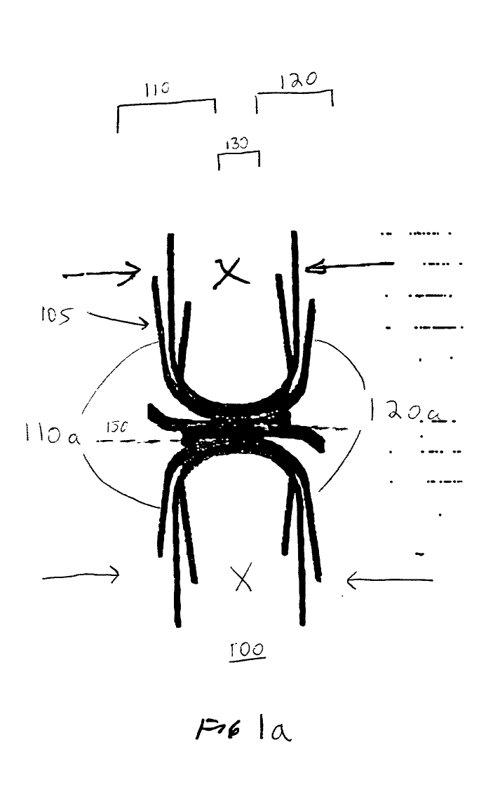

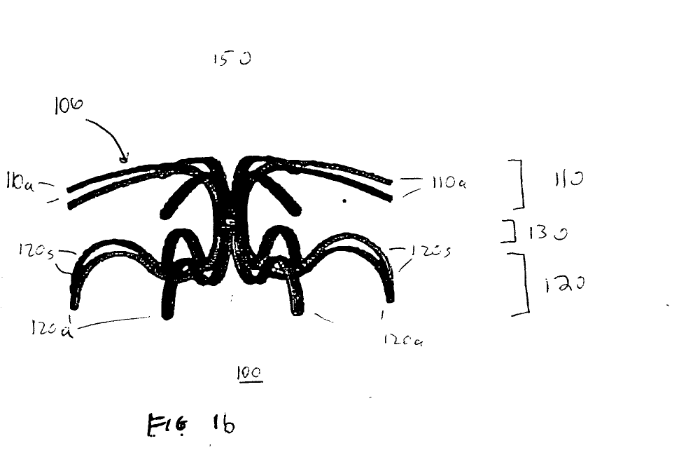

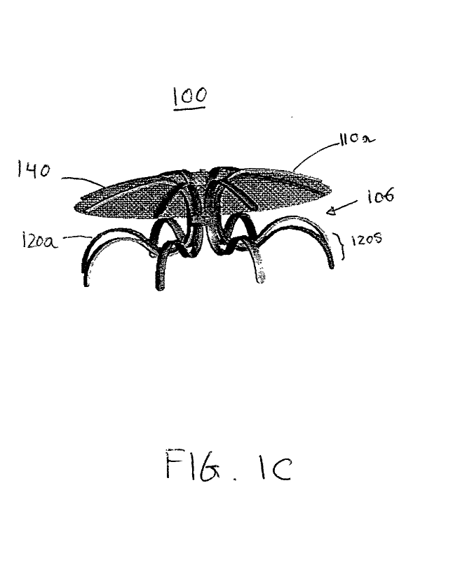

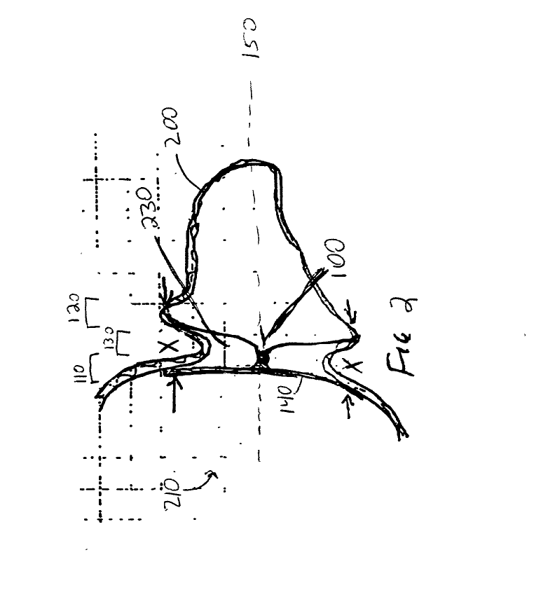

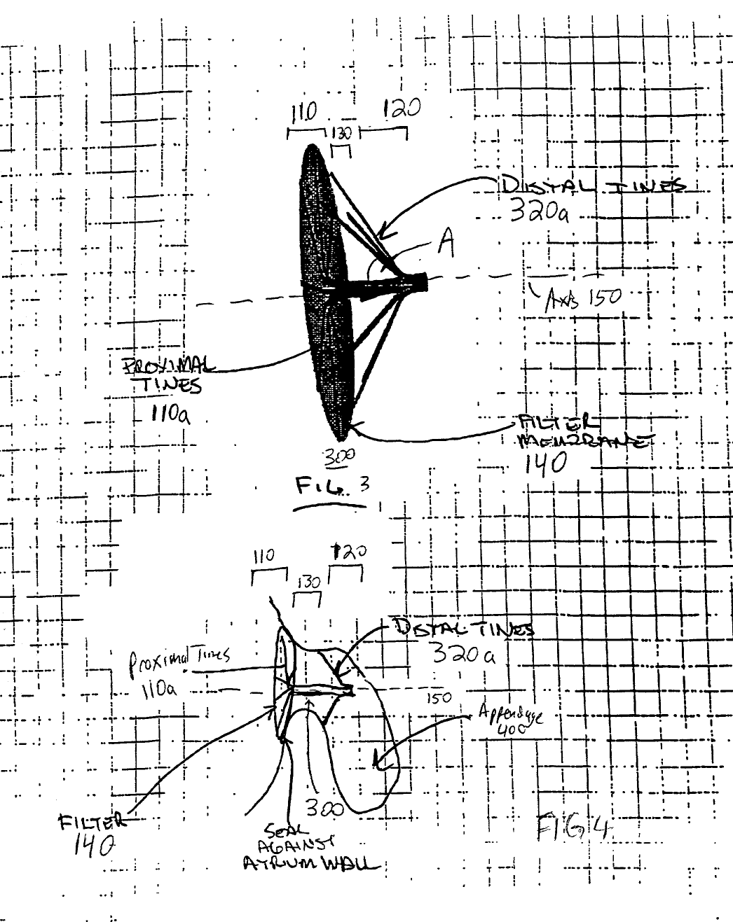

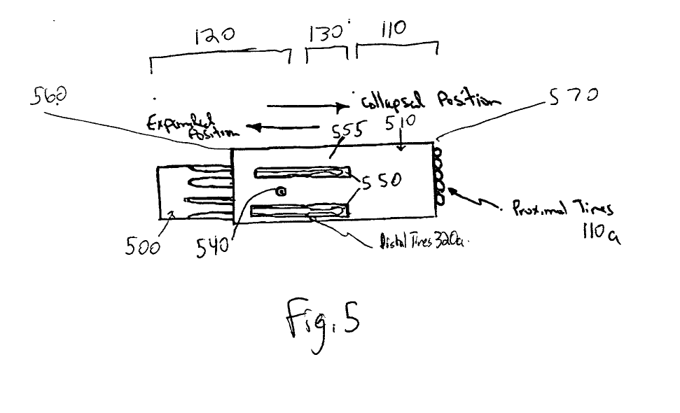

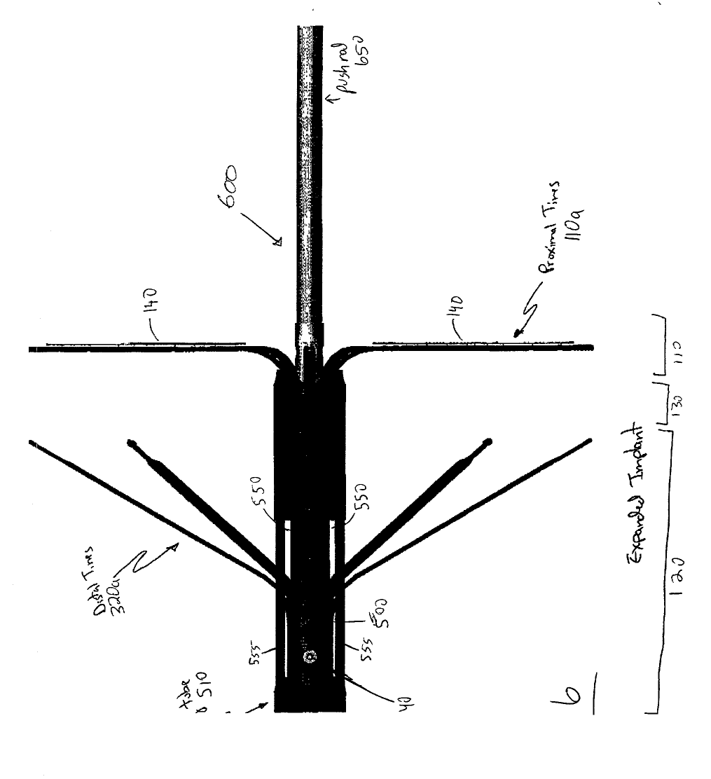

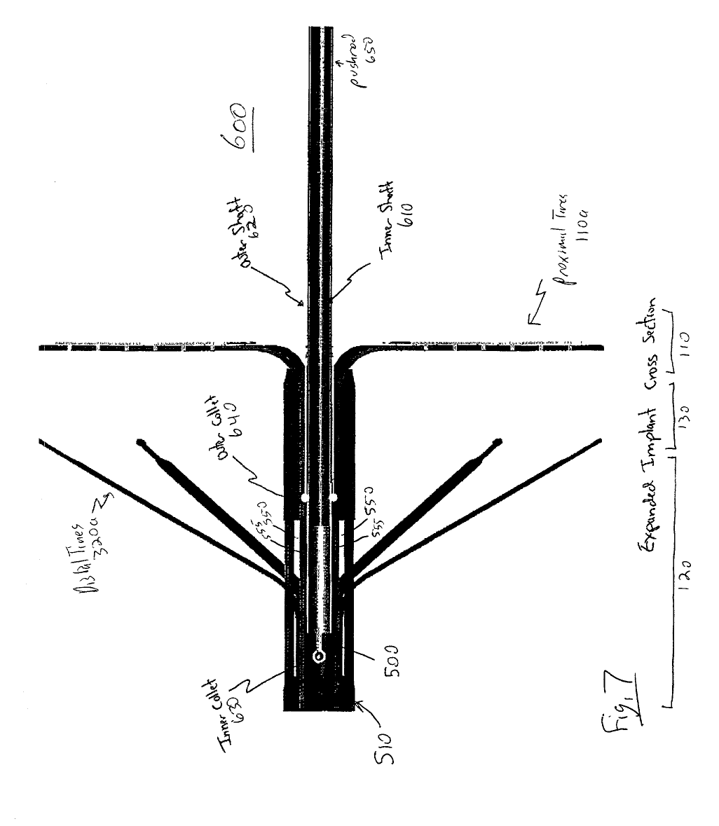

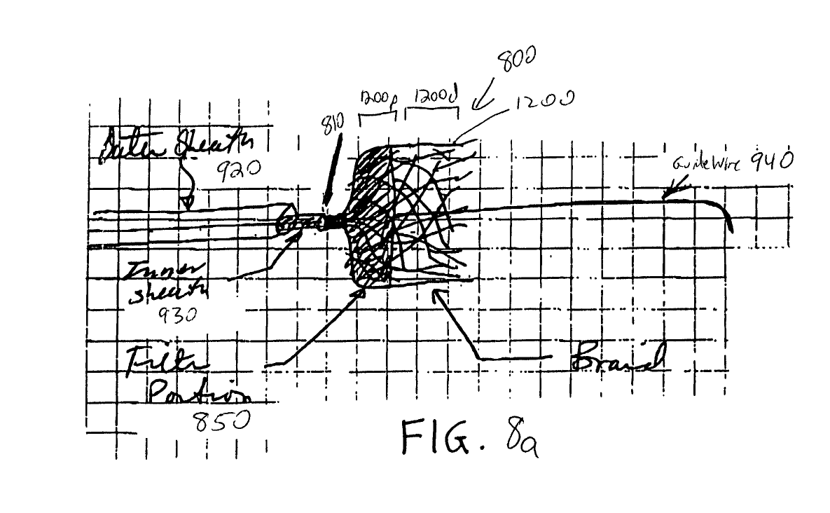

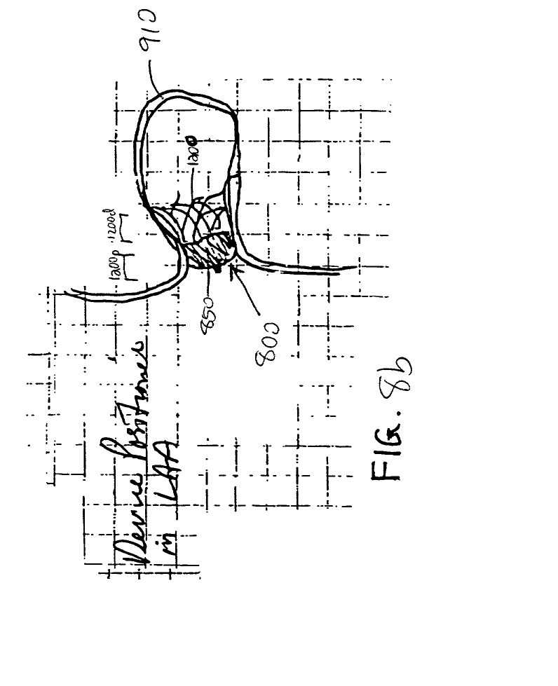

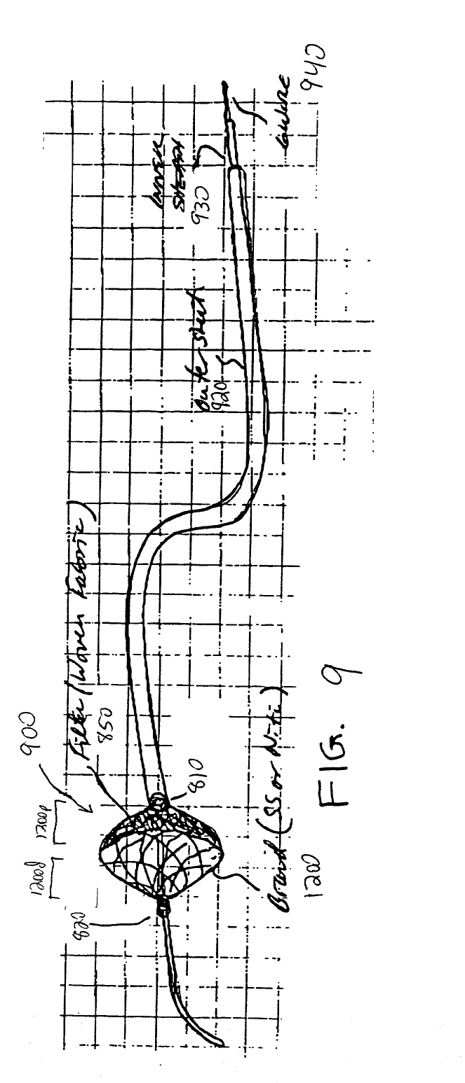

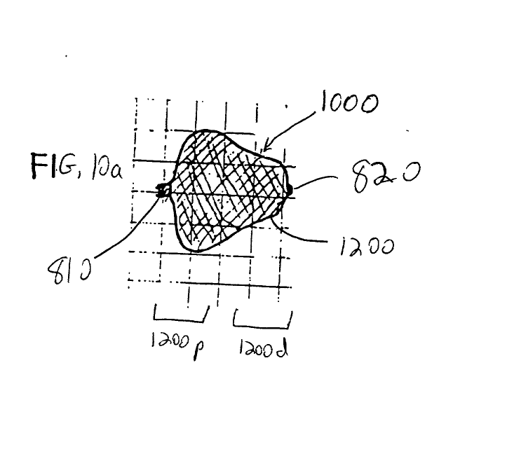

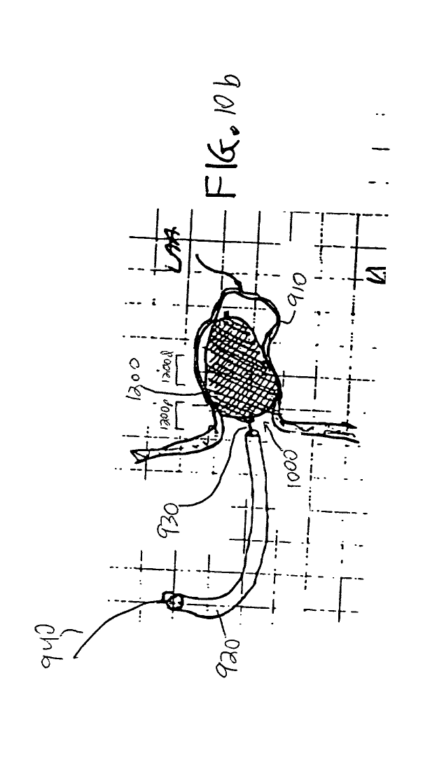

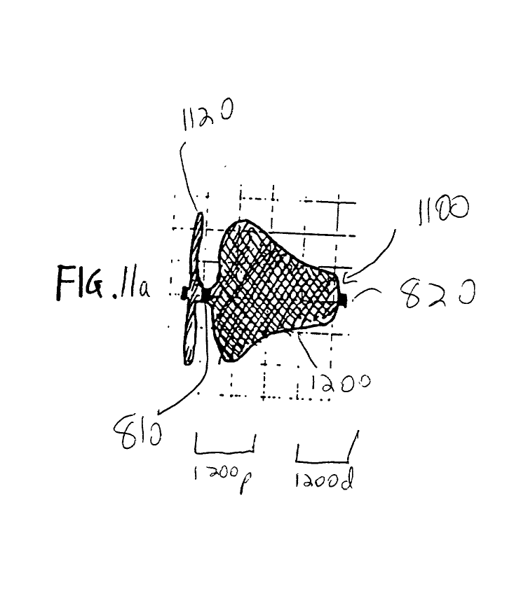

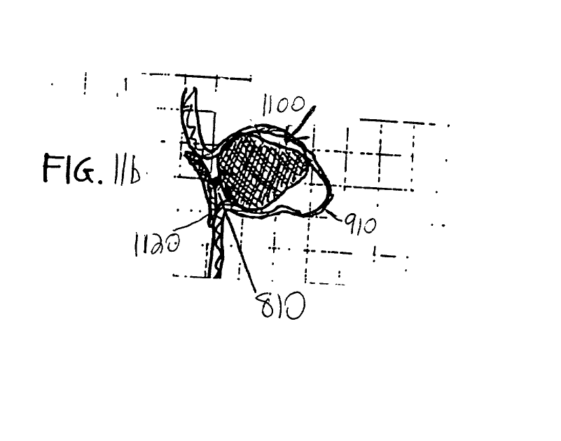

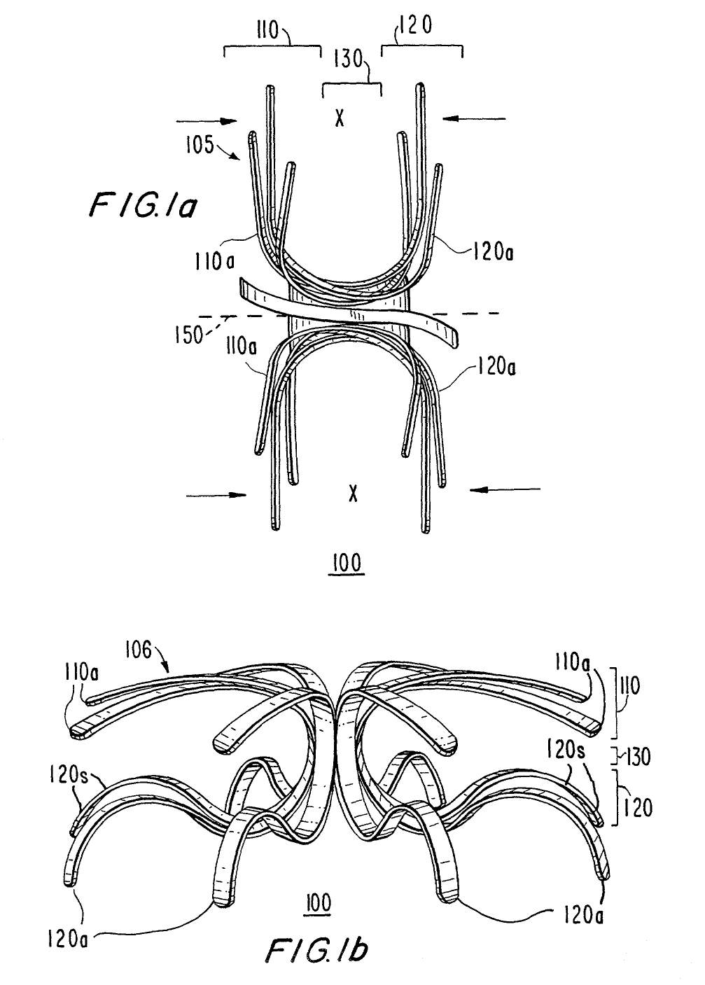

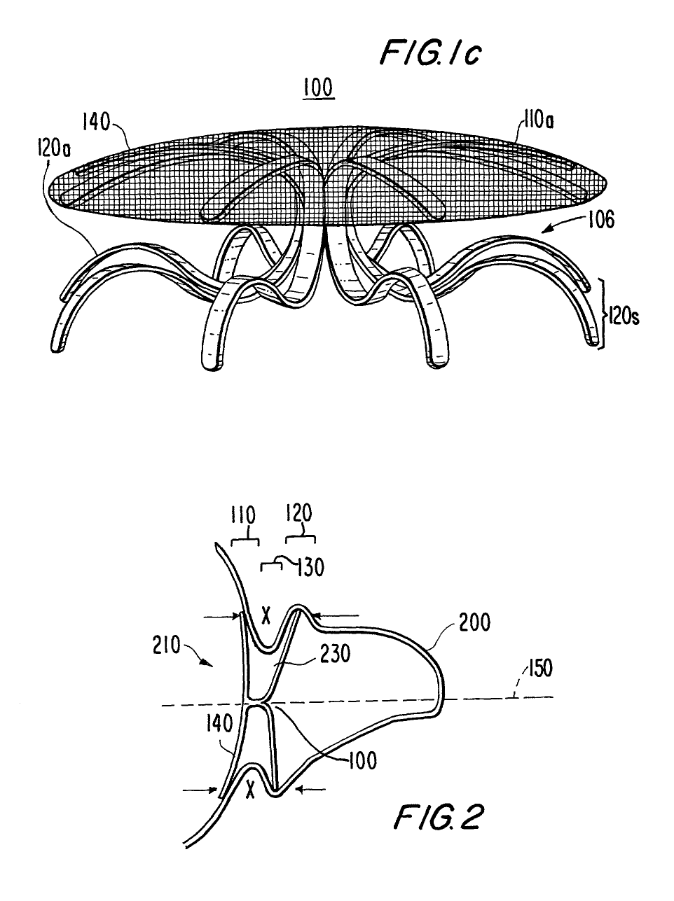

FIGS. 1a, 1b, and 1c illustrate exemplary structures of device 100, which has an H-shaped cross-section. FIG. 2 schematically illustrates, in cross sectional view, H-shaped device 100 deployed to filter blood flow from atrial appendage 200. Device 100 may have a supporting frame, for example, frame 105 or 106. The device frames may have one or more substructures, for example, proximal cover substructure 110 and distal anchoring substructure 120. The two portions include a plurality of elastic ribs or tines 110a and 120a, respectively. The two portions are structurally connected by device middle section 130. Tines 110a and 120a generally extend radially outward from middle section 130, and thus give device 100 an H-shaped cross section. Tines 110a and 120a may be folded toward axis 150 of middle section 130 to give device 100 a compact tubular size that can fit in a delivery catheter tube.

Proximal cover 110 includes blood-permeable filtering element 140, which may, for example, be a circular or a disc-shaped filter membrane (FIG. 1c). When device 100 is deployed (FIG. 2), proximal cover 110 is placed across ostium 230 to interdict blood flow therethrough. The circumferential end portions of proximal cover 110 engage atrial wall portions surrounding ostium 230 to seal atrial appendage 200. Distal anchoring substructure 120 engages atrial appendage wall tissue near ostium 230 to secure device 100 in its deployed position. Ostium 230 tissue may be pinched between proximal cover 110 and distal anchoring substructure 120. The pinching of ostium 230 tissues around its circumference may effectively seal atrial appendage 200 and prevent seepage of unfiltered blood around the periphery of proximal cover 110.

Filtering element 140 may be made from biocompatible materials, for example, fluoropolymers such as ePFTE (e.g., Gortex®) or PTFE (e.g., Teflon), polyester (e.g., Dacron°), silicone, urethane, metal fibers, and any other suitable biocompatible material. Conductive holes are provided in filtering element 140 material to make filtering element 140 blood permeable. As used herein, it will be understood that the term hole refers to an opening, which provides a continuous open channel or passageway from one side of filtering element 140 to the other. The hole sizes in filtering element 140 may be chosen to be sufficiently small so that harmful-size emboli are filtered out from the blood flow between appendage 200 and atrium 210 (shown partially in FIG. 2). Yet the hole sizes may be chosen to be sufficiently large to provide adequate flow conductivity for emboli-free blood to pass through device 100. The hole sizes may range, for example, from about 50 to about 400 microns in diameter. The hole size distribution may be suitably chosen, for example, with regard to individual circumstances, to be larger or smaller than indicated, provided such holes substantially inhibit harmful-size emboli from passing therethrough. The open area of filter element 140 is preferably at least 20% of its overall surface area, although a range of about 25-60% may be preferred.

The hole size distribution in filter element 140, described above, allows blood to flow therethrough while blocking or inhibiting the passage of thrombus, clots, or emboli formed within the atrial appendage from entering the atrium of the heart and, eventually, the patient's bloodstream.

With reference to FIGS. 1a, 1b and 1c, filtering element 140 in proximal cover 110 is supported on elastic ribs or tines 110a. Tines 110a and 120a may be made fabricated from any suitable elastic material including metallic and polymeric materials. Tines 110a and 120a may, for example, be fabricated from known shape-memory alloy materials (e.g., Nitinol®). Conventional fabrication processes may be used to fabricate tines 100a and 120a. In one such device fabrication process, laser milling or cutting may be used to machine a solid preform from a nitinol tube. Longitudinal slots are cut in the walls of a cylindrical section of a nitinol tube. The slots extend a suitable length inward from either ends of the cylindrical section. Material strips between adjacent slots form the proximal cover and anchoring substructure tines (e.g., tines 110a and 120a). An uncut central portion of the nitinol tube may structurally connect the two sets of tines. The preform is then further processed or shaped to fabricate a device structure (e.g., structures 105 or 106). Tines 110a and 120a may, for example, be respectively raised toward each other from opposite ends of the uncut central portion. The raised tines flare radially outward from the uncut central portion to form the proximal cover and anchoring substructures with diameters, which may be considerably larger than the starting nitinol tube diameter.

The anchoring substructure diameter is selected to provide an interference fit when device 100 is lodged in an atrial appendage. Anchoring tines 120a may be suitably shaped or curved to provide atraumatic contact with the atrial appendage walls, and to exert outward elastic pressure against the atrial appendage walls to hold or retain device 100 in place. FIG. 1a shows, for example, curved tines 120a with tine edges that are rounded to render them atraumatic. optionally or additionally, tines 120a may be covered with soft material coverings and/or provided with atraumatic bulbs or ball tips (e.g., device 500 FIGS. 5, 6 and 7). Optionally, the anchoring tines may be further curved to provide contact surfaces 120s, which are generally parallel to device axis 150. FIG. 1b shows, for example, tines 120a with contact surfaces 120s generally parallel to device axis 150. When device 100 is deployed flat sides of tines 120a (i.e., contact surfaces 120s FIGS. 1b and ic) provide atraumatic contact with the atrial appendage walls.

As mentioned earlier, tines 110a generally extend radially outward from middle section 130. The ends of extended tines 110a also may optionally be turned or curved toward distal substructure 120 (downward in FIGS. 1b and 1c) so that proximal cover 110 has a generally concave shape toward distal substructure 120. This downward curvature of elastic tines 110a may bias tines 110a to press circumferential regions of proximal cover 110 against an annular region of atrial wall tissue surrounding the ostium in which device 100 is deployed. Similarly, radially extending tines 120a, which form anchoring substructure 120 may be turned or curved toward proximal cover 110 (upward in FIGS. 1b and 1c). This upward curvature of elastic tines 120a may bias tines 120a to press an annular region of atrial appendage wall tissue surrounding the ostium (in which device 100 is deployed) toward proximal cover 110.

This mutual biasing of elastic tines 110a and 120a toward each other contributes to pinching of an annular region of ostium wall tissue between the proximal cover 110 and anchoring substructure 120, when device 100 is deployed in an atrial appendage. The separation between tines 110a and 120a (indicated by separation distance “X” in FIGS. 1a and 2) may be suitably chosen to be sufficiently small so as to enclose or pinch ostium wall tissue to effectively seal the atrial appendage. The suitably chosen separation distance X may be small relative to atrial appendage sizes. A small separation distance X between tines 110a and 120a corresponds to H-shaped device 100 with a small axial length.

The H-shape and the small axial device length allow devices such as device 100 to be deployed and secured entirely within the immediate vicinity of an atrial appendage ostium. Since the anchoring substructures of the inventive H-shaped devices (e.g., device 100) do not extend deeply into atrial appendages, the use of such devices advantageously avoids individualized device sizing that may be otherwise required to match a patient's atrial appendage size or shape. One (or a few) universal device size(s) maybe used for atrial appendages of varying sizes and shapes.

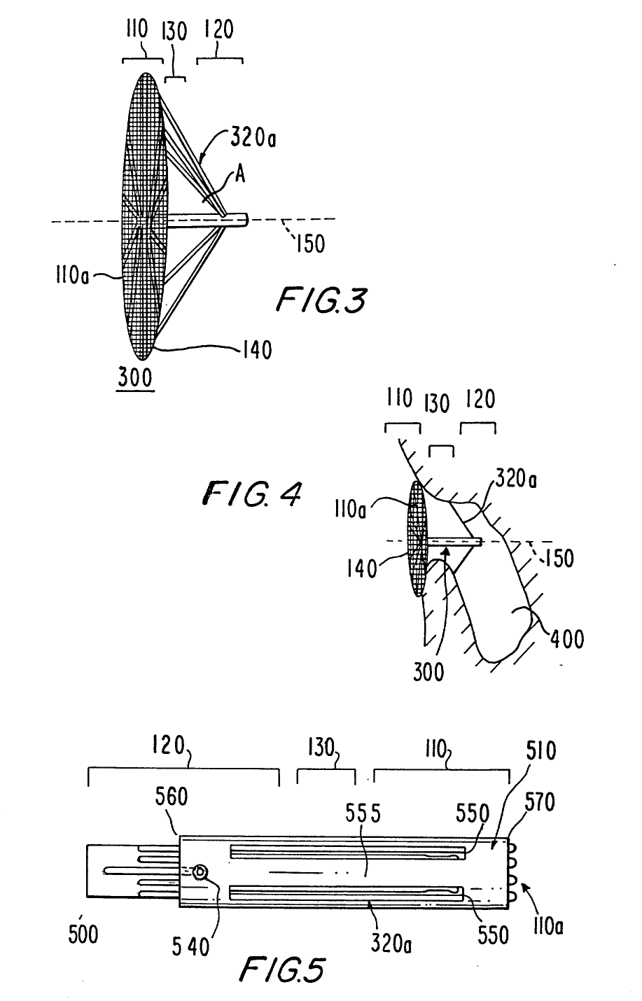

Another configuration of anchoring tines that may be used in the inventive devices is shown in FIG. 3. Device 300 anchoring substructure 120 has tines 320a, which may generally point toward the proximal end of device 300. Tines 320 may form an acute angle “A” with axis 150 of middle section 130 (extending toward proximal cover 110) as shown in FIG. 3. Thus, anchoring substructure 120 in cross section is generally V-shaped (or arrow shaped) with a vertex at the distal end of device 300. This configuration of tines 320a may provide a hook or harpoon-like action against atrial appendage walls tissues to prevent device 300 from dislodging out of an atrial appendage in which it has been deployed. FIG. 4 shows, for example, device 300 deployed in atrial appendage 400. Tines 110a elastically press proximal cover 110 against the atrial walls surrounding the appendage ostium to seal appendage 400. The tips of tines 320a engage the interior walls. The V-shaped cross section of tines 320a points toward the rear of appendage 400. Any forward dislodging movement of device 300, tends to bend wall-contacting tines 320a backward (wider apart). This backward bending meets elastic resistance due to the particular configuration of tines 320a that are structurally connected to the distal end of middle section 130. Any forward dislodging movement also meets resistance due to the hook-like engagement of the appendage walls by tines 320a.

Device 300 may be fabricated in a manner generally similar to that described above, for example, by laser cutting a nitinol tube. Tines 320a also may have optional atraumatic features similar to those described above in the context of tines 120a. These features may include shape curves, which allow flat sides of tines 320a to engage or contact atrial wall tissue.

An inventive device such as device 100 or 300 may be deployed at an atrial appendage by simply pushing and expelling the device from the catheter tube end, which has been inserted in the atrial appendage. A push rod sliding through the catheter tube may be used to move the device through the catheter tube. The inventive devices may optionally include fixtures (e.g., threaded sockets attached to middle section 130) to which delivery shafts or guide wires may be attached or pass through. The attached shafts or wires may be used for guiding the device through the catheter tube and for more controlled release and deployment of the device at an atrial appendage.

The devices also may include optional fixtures for mechanically folding or unfolding the device tines. Such fixtures can be useful in inserting folded devices in catheter delivery tubes, and in deploying devices in vivo. Such fixtures also may allow a deployed device to be recovered, for example, for repositioning during a catheterization procedure or for complete withdrawal from the body.

FIG. 5 shows device 500 with such a fixture (recovery tube 510), which may be used to mechanically fold and unfold device tines 110a and 320a. Recovery tube 510 is disposed coaxially around device middle section 130. Recovery tube 510 can slide along middle section 130. Recapture tube 510 may be fabricated from any suitable rigid biocompatible material, for example, stainless steel, nitinol, thermoset polymers, or, thermoplastic polymers. Conventional mechanical designs may be used to structurally connect recovery tube 510 and middle section 130. For example, pins 540, which can slide in longitudinal slots (not shown) in middle section 130, may be used to connect recovery tube 510 and middle section 130.

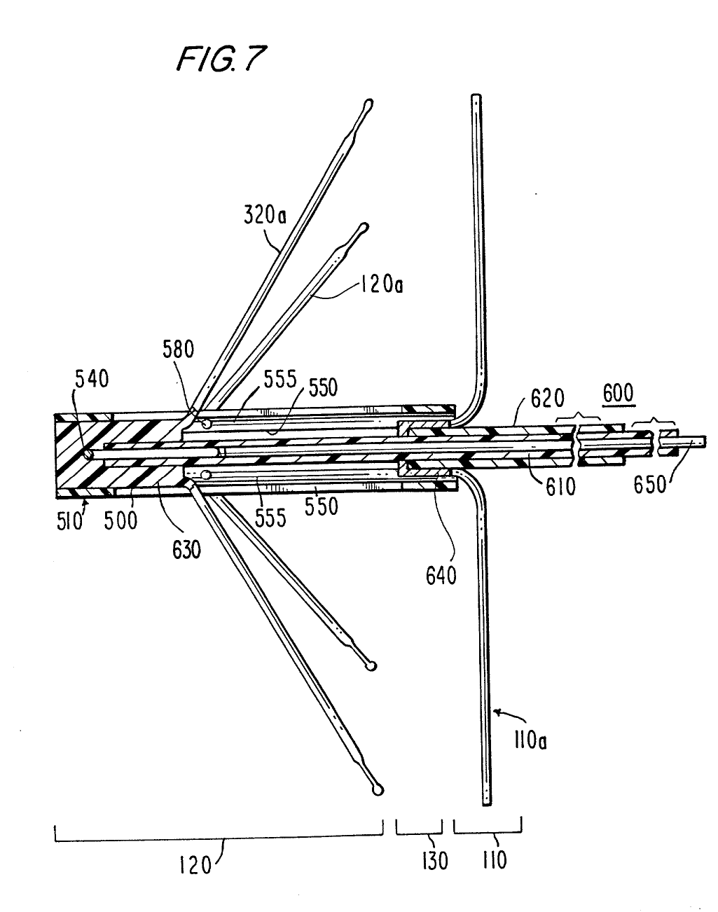

Recovery tube 510 walls may have other cut-outs or slots 550. When recovery tube 510 is slid toward a device expansion position (to the left in FIG. 5) tines 320a can expand away from device 500 axis through slots 550. The tube material (i.e., stems 555) between slots 550 structurally joins or connects tube cylindrical ends 560 and 570. When recovery tube 510 is slid toward a device contraction position (to the right in FIG. 5) cylindrical ends 560 and 570 slide over and press or fold tines 320a and 110a, respectively, along middle section 130. Device 500 structure may include conventional detents, levers or catches (e.g., pins 540 and detents 580 FIG. 7) to lock or unlock movement of device components relative to each other. These detents may be remotely engaged or activated to control the sliding operation of recovery tube 510 using a suitable delivery system.

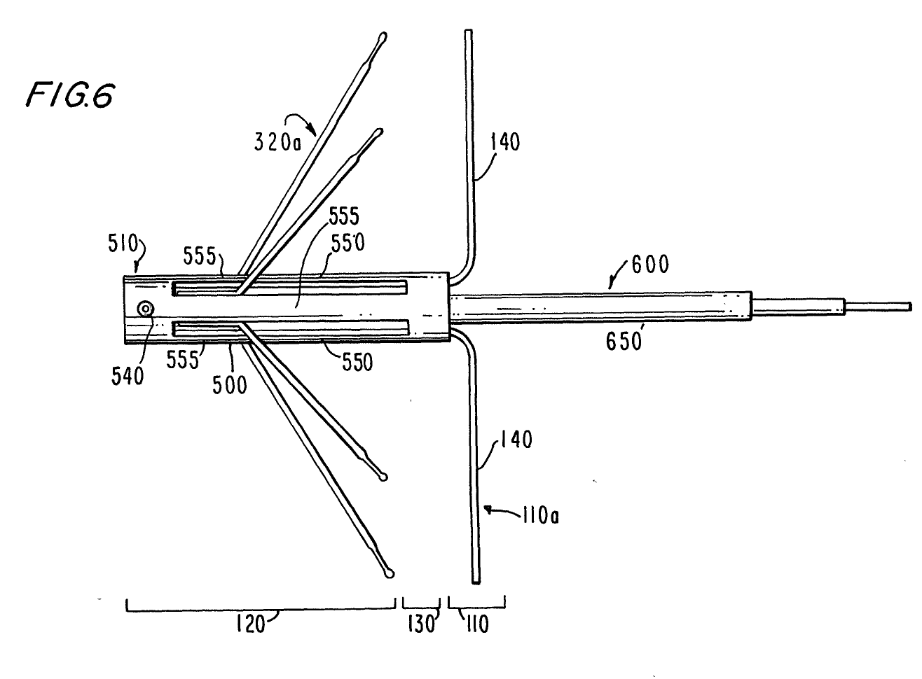

Portions of a delivery system 600 that may be used to remotely operate recovery tube 510 are shown in FIGS. 6 and 7. The FIGS. illustrate the operation delivery system 600 in conjunction with device 500. Device 500 is mounted or attached to the distal end of device push rod 650 in delivery system 600. Delivery system 600 may be passed to in vivo location through a catheter sheath (not shown) with attached device 500, or to engage a previously positioned device 500. Delivery system 600 may be used to push recovery tube 510 to the device expansion position at which tines 120a and 320a are free to expand through slots 550. Alternatively, delivery system 600 may be used to pull recovery tube 510 toward the device contraction position over tines 120a and 320a for device recovery or readjustment. Delivery system 600 includes coaxial inner shaft 610 and outer shaft 620 around push rod 650. Shafts 610 and 620 terminate in collets 630 and 640, respectively. Shafts 610, 620 and push rod 650 may slide relative to each other.

In operation, outer shaft 620 position is slid or adjusted along push rod 650 so that collet 640 engages device middle section detents 580. Then, middle section 130 may be immobilized by keeping outer shaft 620 immobile. Further, inner shaft 610 position is slid or adjusted along push rod 650 so that collet 630 engages recovery tube 510 detents (pins 540). With middle section 130 immobilized, recovery tube 510 may be slid along middle section 130 between the expansion position and the contraction position by respectively pushing in or pulling out inner shaft 610 over push rod 650. After device 500 has been suitably deployed by allowing tines 120a and 320a to expand through slots 550 with recovery tube 510 at the expansion position, push rod 650 may be disengaged from device 500, and delivery system 600 withdrawn from the catheter sheath. Alternatively if desired, with recovery tube 510 at the contraction position, a contracted device 500 attached to push rod 650 may be withdrawn or relocated by pulling delivery system 600 out of the catheter sheath.

Delivery system 600 components such as inner shaft 610, outer shaft 620, and push rod 650 may be fabricated from suitable metallic or polymeric materials.

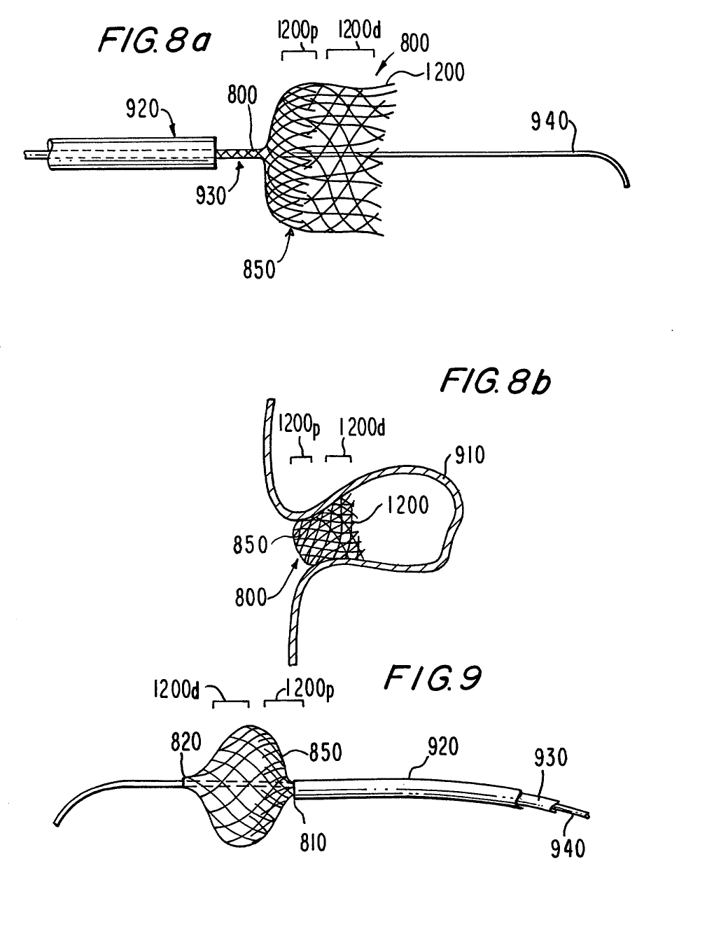

In other device embodiments, a single structure fabricated from braided elastic wire may provide the functions of both the proximal cover and anchoring substructures 110 and 120 described above. The braided wires may be made of metallic, plastic, or polymeric material or any combinations thereof. The fabrication materials are chosen so that the device structure can be reversibly compacted to a suitable size for delivery through a catheter sheath. Exemplary devices 800, 900, and 1000 having braided wire device structures 1200 are shown in shown in FIGS. 8a, 9, and 10a, respectively. The braided wire device structures 1200 may, for example, be fabricated using nitinol wire braid preforms. The starting wire braid material may, for example, be in the form of a tube or cylinder. The wire braid preforms may be heat treated, for example, over a mandrel, to obtain device structures 1200 of various cylindrical shapes. The cylindrical shapes may be chosen with consideration to device usage as body cavity or atrial appendage implants. Device structures 1200 having various balloon-like cylindrical shapes are shown, for example, in FIGS. 8a, 9, and 10a, respectively. Device structure 1200 diameters may be varied along the structure length keeping in consideration the shapes of atrial appendages in which the devices are deployed, in order to obtain interference fits in the atrial appendages. The diameters of the proximal portions of device structures 1200 may be selected to be comparable or larger than the atrial appendage ostium diameters so that the deployed devices effectively intercept all blood flow through the appendage ostiums.

Wire braid device structures 1200 may be tied, crimped, or banded together to close off the proximal device structure 1200 ends. Bands 810, for example, bind the proximal ends of device structure 1200 in devices 800, 900, and 1000. Optionally, the distal ends of device structure 1200 may be similarly closed off. For example, bands 820 close off the distal end of device structures 1200 in devices 900, and 1000. Bands 810 and 820 may be made of suitable materials including metals and polymers. Bands 810 and 820 may, for example, be made of radio opaque material. Bands 810 and 820 also may include conventional fixtures such as bushings or threaded sockets (not shown) for passing catheter guide wires through the devices or for attaching delivery wires or shafts to the devices.

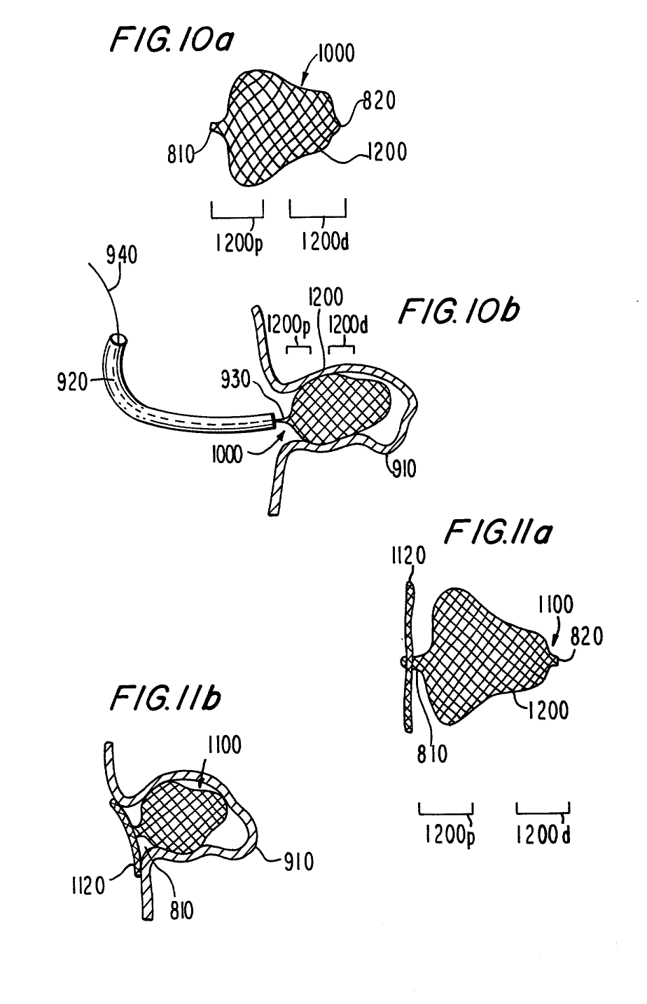

Devices 800, 900, or 1000 may be delivered to an atrial appendage using, for example, conventional catheter apparatus. Portions of a conventional catheter delivery apparatus that may be used to deliver the devices are shown, for example, in FIGS. 8a, 9 and 10b. The apparatus includes outer catheter sheath 920, inner sheath 930, and guide wire 940. Conventional cardiac catheterization procedures (including transseptal procedures) may be used to advance outer sheath 920 over guide wire 940 through a patient's vasculature to an atrial appendage (e.g., atrial appendage 910 FIGS. 8b and lob). Compacted implant devices may be attached to the inner sheath 930 using the conventional fixtures such as the threaded sockets mentioned above. The attached devices are advanced to atrial appendages 910 by sliding inner sheath 930 through outer sheath 920 over guide wire 940 (e.g., device 1000 FIG. 10b).

The attached devices expand once they are pushed ahead of or expelled from outer sheath 920. FIGS. 8a, 9, and lob show, for purposes of illustration, devices 800, 900, and 1000 in their expanded state outside of outer sheath 920. Inner sheath 930 may be detached and withdrawn after the devices have been suitably deployed (e.g., device 800 FIG. 8b).

When device 800, 900, or 1000 is deployed in an atrial appendage (e.g., appendage 910 FIGS. 8 and 10b) distal portions 1200d of device structure 1200 engage atrial appendage walls to anchor devices in the atrial appendage. Proximal portions 1200p of device structure 1200 extend across the ostium of the appendage.

Proximal portions 1200p may be designed to include a blood-permeable filter to prevent emboli from passing through the atrial appendage ostium. The filter may be made from membrane materials such as ePFTE (e.g., Gortex®), polyester (e.g., Dacron®), PTFE (e.g., Teflon®), silicone, urethane, metal or polymer fibers, or of any other suitable biocompatible material. The filter membranes may have fluid conductive holes. The holes may be present as interfiber spacing in woven fabrics or as interwire spacing braided materials, or may be created in solid membrane material, for example, by laser drilling. The hole sizes in the filter membrane may be selected to filter harmful-sized emboli.

FIGS. 8a, 8b, and 9 show, for example, filter membrane 850 on proximal device portions 1200p of devices 800 and 900, respectively. Filter membrane 850 may, for example, be formed of a piece of woven polyester fabric. Filter 850 may be fixed to the underlying wire braid of proximal portions 1200p, for example, by adhesives, heat fusion, or suture ties. Optionally, filter membrane 850 may be interwoven or interbraided with the underlying wire braid of proximal portions 1200p using fine metal wires or polymer fibers. Size 24-72 fine wires made of nitinol or stainless steel may be suitable for fabricating the interwoven filter membrane 850.

In yet another embodiment of the invention, the implant device may be made of a high-density metallic wire braid. The high-density structure allows the implant to be placed in the LAA and have enough structure to hold position while, additionally, acting as a filter to stop emboli from exiting the LAA.

In these device embodiments, entire device structure 1200 may be formed of high-density wire braid materials. The density may be chosen so that the interwire hole sizes are sufficiently small to block the passage of harmful-sized emboli. Device structure 1200 with a suitably high-density wire braid may itself act as a blood-permeable filter, and thereby dispense with the need of a separate filter element. FIGS. 10a and 10b show, for example, device 1000 having high-density wire braid device structure 1200. The high-density wire braid may be formed of shape-memory alloy materials such as nitinol wire. Alternative materials such as stainless steel or polymer fibers also may be used to fabricate the high-density wire braid device structure 1200. In one fabrication process, the high density is obtained by interbraiding different size wires and/or different material wires. Using different wire sizes in the wire braids may allow fabrication of device structure 1200 of suitable structural strength with smaller interwire hole sizes than is possible in single wire size braids. For example, a fine polymer fiber may be interwoven with size 22-74 size nitinol wire to obtain a wire braid with hole sizes smaller than may be possible using the nitinol wire alone. The hole size distribution is determined by the size and amount of the polymer fiber used in the interwoven wire braid. This distribution may be chosen to provide effective filtering of harmful emboli.

In a further device embodiment, a distinct proximal cover substructure may be formed or attached to cylinder-shaped wire braid device structures 1200 of the previous embodiments. FIGS. 11a and 11b show, for example, device 1100 in which a proximal cover 1120 is attached to wire braid device structure 1200. Proximal cover 1120 acts to cover and seal the ostium of atrial appendage 910, as is illustrated, for example, in FIG. 11b. Proximal cover 1120 may be have a wire braid structure or have any other suitable structure, for example, the tine supported structure similar to that of proximal cover 110 described earlier. (FIGS. 1a, 1b, and ic). Proximal cover 1120 may include suitable filtering membranes or elements for filtering emboli. These membranes or elements may, for example, be similar to filter membrane 850 or filter element 140 described earlier (FIGS. 8a and 1c).

It will be understood that the foregoing is only illustrative of the principles of the invention, and that various modifications can be made by those skilled in the art without departing from the scope and spirit of the invention. It will be understood that terms like “distal” and “proximal”, “forward” and “backward”, “front” and “rear”, and other directional or orientational terms are used herein only for convenience, and that no fixed or absolute orientations are intended by the use of these terms.

1. A device for filtering blood flow through a body aperture, comprising:
a cover comprising a filter, said cover disposed on a multiplicity of tines extending radially outward from a device axis;
an anchoring structure comprising a plurality of anchoring tines, said plurality of tines extending radially outward from said axis; and
a connecting structure along said axis joining said cover and said anchoring structure,
wherein said device has a substantially H-shaped cross-section, and wherein said cover and said anchoring structure are placed on opposite sides of said body aperture.

2. The device of claim 1 wherein said tines are biased so that said multiplicity of tines press said cover against body tissue surrounding said aperture, and said plurality of anchoring tines are biased to press against body tissue surrounding said aperture from the side opposite said cover.

3. The device of claim 1 wherein said filter comprises a blood-permeable filter.

4. The device of claim 3 wherein said blood-permeable filter comprises material selected from the group of fluoropolymers, silicone, urethane, metal fibers, polymer fibers, polyester fabric, and combinations thereof.

5. The device of claim 1 wherein said tines can be folded substantially parallel to said device axis.

6. The device of claim 1 wherein said tines comprise elastic material selected from the group of metals, plastics, polymers, metal alloys, shape-memory alloys, and combinations thereof.

7. The device of claim 6 wherein said tines comprise nitinol.

8. The device of claim 1 wherein said tines and said connecting structure are fabricated from a solid tubular preform.

9. The device of claim 8 wherein said solid tubular preform comprises a shape-memory alloy tube.

10. The device of claim 1 wherein said anchoring structure provides interference fit with a body cavity on one side of said aperture.

11. The device of claim 10 wherein said anchoring tines are shaped to present substantially flat surfaces for contact with said body cavity walls.

12. A method for filtering blood flowing through the ostium of an atrial appendage, comprising:
providing a device having a substantially H-shaped cross section, said device comprising a cover disposed on a multiplicity of tines extending radially from a device axis, said cover including a filter;
an anchoring structure joined to said cover by a connecting structure that is along said device axis, said anchoring structure comprising a plurality of anchoring tines extending radially from said axis;
inserting a portion of said device in said atrial appendage;
positioning said cover and said anchoring structure on opposite sides of said ostium.

13. The method of claim 12 wherein said positioning comprises pinching ostium tissue between said cover and said anchoring structure to direct blood flow through said filter.

14. The method of claim 13 wherein said inserting further comprises folding said tines substantially parallel to said device axis;
delivering said device with folded tines through a catheter tube; and
expelling said device from said catheter tube to allow said tines to unfold.

15. A device for filtering blood flowing through the ostium of an atrial appendage, comprising:
a cover comprising a filter, wherein said cover extends across said ostium; and
an anchoring structure comprising a plurality of anchoring tines extending radially from a connecting structure that joins said anchoring structure to said cover,
wherein said anchoring structure has a substantially V-shaped cross-section with a vertex pointing away from said cover, and said anchoring structure engages the interior walls of said atrial appendage to retain said device in position.

16. The device of claim 15 wherein said anchoring tines are biased so that said anchoring structure engages said interior walls with a hook-like action to resist outward movement of said device.

17. The device of claim 15 wherein said anchoring tines can be folded substantially along said connecting structure.

18. The device of claim 15 wherein said anchoring tines comprise elastic material selected from the group of metals, plastics, polymers, metal alloys, shape-memory alloys, and combinations thereof.

19. The device of claim 18 wherein said anchoring tines comprise the shape memory alloy nitinol.

20. The device of claim 15 wherein said tines and said connecting structure are fabricated from a solid tubular preform.

21. The device of claim 15 wherein said cover further comprises a multiplicity of tines extending radially away from said connecting structure.

22. The device of claim 21 wherein said multiplicity of tines are biased so that said tines press said cover against atrial wall tissue surrounding said ostium.

23. The device of claim 21 wherein said multiplicity of tines and said anchoring structure comprise a shape-memory alloy.

24. The device of claim 15 wherein said filter comprises material selected from the group of fluoropolymers, silicone, urethane, metal fibers, polymer fibers, polyester fabric, and combinations thereof.

25. A device for filtering blood flow through a body aperture, comprising:
a cover comprising a filter, an anchoring structure; and
a connecting structure joining said cover and said anchoring structure; and
a slideable recovery tube disposed on said connecting structure,
wherein said cover and said anchoring structure reversibly fold along said connecting structure, and wherein said recovery tube slides to a first position to fold said cover and said anchoring structure and said recovery tube slides to a second position to unfold said cover and said anchoring structure.

26. The device of claim 25 wherein said cover and said anchoring structure further comprise tines that radially extend from said connecting structure and that can be folded substantially along said connecting structure.

27. The device of claim 26 wherein said recovery tube comprises a slot through which a folded tine unfolds and extends radially away from said connecting structure when said recovery tube slides to said second position.

28. The device of claim 26 wherein said recovery tube comprises ends which press down and slide over said tines to fold them along said connecting structure when said recovery tube slides to said first position.

29. The device of claim 25 wherein said recovery tube and said connecting structure further comprises detents, wherein said detents can be engaged to lock movement of said recovery tube and said connecting structure.

30. A delivery system for reversible implantation of the device of claim 29, comprising:
a catheter tube in which said device fits when said recovery tube is at said first position;
a first shaft slideable through said catheter tube, said first shaft having a first collet that can engage said detents to lock the movement of said connecting structure to the movement of said first shaft;
a second shaft slideable through said catheter tube, said second shaft having a second collet that can engage said detents to couple the movement of said recovery tube to the movement of said second shaft; and
a third shaft for moving said device through said catheter tube.

31. A method for reversibly placing an implant device in a body cavity through a catheter tube, comprising:
providing an implant device comprising:
a tubular section;
structures that can be reversibly folded along said tubular section; and
a sliding tube disposed on said tubular section,
wherein said sliding tube slides to a first position to fold said structures and slides to a second position to unfold said structures, and wherein said tubular section and said sliding tube further comprise detents that can be engaged to lock their movements;
moving said device with said sliding tube at said first position through said catheter tube to said body cavity; and
sliding said sliding tube to said second position to unfold said structures.

32. The method of claim 31 further comprising:
providing a first shaft slideable through said catheter tube, said first shaft having a first collet that can engage said detents to lock the movement of tubular section to the movement of said first shaft;
providing a second shaft slideable through said catheter tube, said second shaft having a second collet that can engage said detents to couple the movement of said sliding tube to the movement of said second shaft; and
providing a third shaft for moving said device through said catheter tube;
using said third shaft to move said device with said tube in said first position through said catheter tube into said body cavity;
using said first shaft to lock the movement of said tubular section;
using said second shaft to couple the movement of said sliding tube to the movement of said second shaft; and
sliding said second shaft to move said sliding tube between said first and second positions.

33. A method of reversing the placement of an implant device placed in a body cavity by the method of claim 32 comprising;
using said first shaft to lock movement of said tubular section;
using said second shaft to couple the movement of said sliding tube to the movement of said second shaft;
sliding said second shaft to move said tube to said first position; and
using said third shaft to move said device with said tube in said first position into said catheter tube.

34. A device for filtering blood flowing through the ostium of an atrial appendage, comprising:
a proximal portion;
a distal portion joined with said proximal portion; and
a filter disposed on said proximal portion, wherein said distal portion comprises a cylindrical braided wire structure and said proximal portion comprises a closed end of said cylindrical braided wire structure, wherein said filter is disposed on said proximal portion, and wherein said braided wire structure is shaped for an interference fit in said atrial appendage and said proximal portion extends across said ostium.

35. The device of claim 34 wherein said wire braided structure is elastic and said structure can be reversibly compacted for delivery through a catheter tube.

36. The device of claim 34 wherein said closed end comprises a band closing a tubular end of said cylindrical braided wire structure.

37. The device of claim 35 wherein said band comprises a fixture for attaching a delivery shaft to said device.

38. The device of claim 34 wherein said cylindrical braided wire structure comprises wires selected from the group of metal wires, plastic wires, polymer wires, metal alloy wires, shape-memory alloy wires, and combinations thereof.

39. The device of claim 38 wherein said cylindrical braided wire structure comprises nitinol wires.

40. The device of claim 34 wherein said filter comprises material selected from the group of fluoropolymers, silicone, urethane, metal fibers, polymer fibers, polyester fabric, and combinations thereof.

41. The device of claim 34 wherein said filter comprises material interwoven with said cylindrical wire braid structure.

42. The device of claim 41 wherein said interwoven material comprises material selected from the group of metal wires, plastic wires, polymer wires and combinations thereof.

43. The device of claim 34 wherein said filter comprises material selected from the group of fluoropolymers, silicone, urethane, metal fibers, polymer fibers, polyester fabric, and combinations thereof.

44. The device of claim 34 wherein said cylindrical braided wire structure further comprises
a braid with interwire hole sizes substantially smaller than harmful-sized emboli.

45. The device of claim 34 wherein said filter comprises a cover attached to said proximal portion, wherein said cover engages atrial wall tissue surrounding said ostium, and wherein said cover includes a filter element.

46. A device for filtering blood flowing through the ostium of an atrial appendage, comprising:
a proximal portion;
a distal portion joined with said proximal portion; and
wherein said distal portion comprises a cylindrical braided wire structure and said proximal portion comprises a closed end of said cylindrical braided wire structure, wherein said braided wire structure is shaped for an interference fit in said atrial appendage and said proximal portion extends across said ostium, and wherein said braided wire structure comprises a braid with interwire hole sizes substantially smaller than harmful-sized emboli.

47. The device of claim 46 wherein said wire braided structure is elastic and said structure can be reversibly compacted for delivery through a catheter tube.

48. The device of claim 46 wherein said cylindrical braided wire structure comprises wires selected from the group of metal wires, plastic wires, polymer wires, metal alloy wires, shape-memory alloy wires, and combinations thereof.

49. The device of claim 48 wherein said cylindrical braided wire structure comprises nitinol wires.

50. A method of implanting the device of claim 47 in body cavity to filter blood flow comprising:
delivering said device with compacted structures through a catheter tube; and
expelling said device from said catheter tube to allow said compacted structures to expand.
